(19) United States
(12) Patent Application Publication
(10) Pub. No.: US 2014/0253604 A1
(43) Pub. Date: Sep. 11, 2014

(54) CONTROL APPARATUS, ELECTRO-OPTICAL APPARATUS, ELECTRONIC DEVICE, AND CONTROL METHOD

(71) Applicant: SEIKO EPSON CORPORATION, Tokyo (JP)

(72) Inventors: Hiroaki KANAMORI, Suwa-shi (JP); Atsushi MIYAZAKI, Suwa-shi (JP); Toshimichi YAMADA, Fujimi-machi (JP); Kota MUTO, Suwa-shi (JP)

(73) Assignee: SEIKO EPSON CORPORATION, Tokyo (JP)

(21) Appl. No.: 14/196,704

(22) Filed: Mar. 4, 2014

(30) Foreign Application Priority Data
Mar. 5, 2013 (JP) 2013-042673

(51) Int. Cl. G09G 3/20

(52) U.S. Cl. CPC G09G 3/2003
USPC 345/690

(57) ABSTRACT

An adjustment phase, a clearing phase, and a gray level control phase are used when changing the gray levels of pixels. A plurality of pixels are aligned to a predetermined gray level in the adjustment phase. In the adjustment phase, the gray level of a pixel is changed earlier the greater a gray level difference between the gray level of the pixel and the predetermined gray level is.

### BACKGROUND

1. Technical Field

The present invention relates to techniques for controlling bi-stable display elements.

2. Related Art

JP-T-2007-513368 discloses a technique for displaying four gray levels, namely black, dark gray, light gray, and white, in an electrophoretic display device. In this display device, when setting a pixel to dark gray, the pixel is first set to black and then changed to dark gray, and when setting a pixel to light gray, the pixel is first set to white and then changed to light gray. JP-T-2007-513368 also discloses a configuration that employs a pulsewidth modulation driving method as a method for driving pixels, where the gray level of a pixel is controlled by controlling the application time, polarity, and so on of a driving voltage applied to the pixel.

When rewriting a displayed image according to the invention disclosed in JP-T-2007-513368, a situation may arise where different pixels have different driving times.

For example, as indicated in the drawings of JP-T-2007-513368, a pixel is changed from black to dark gray by applying a negative voltage at ⅓ pulsewidth of the full pulsewidth required to change a pixel from black to white (or from white to black). On the other hand, a pixel is changed from white to dark gray by first applying a positive voltage at the full pulsewidth to set the pixel to black and then applying a negative voltage at ⅓ pulsewidth to change the pixel to dark gray.

To compare the case of changing from black to dark gray with the case of changing from white to dark gray, when changing from black to dark gray, the electrophoretic particles are moved from a resting state, whereas when changing from white to dark gray, the pixel is first changed from white to black so that the electrophoretic particles are in a more mobile state, after which the electrophoretic particles are moved by applying the negative voltage at ⅓ pulsewidth.

The motion of electrophoretic particles differs between when the electrophoretic particles are moved from a resting state and when the electrophoretic particles are moved from a more mobile state, and thus even if the same gray level is to be displayed, differences will arise in the displayed gray level depending on the image present before the rewrite.

### SUMMARY

An advantage of some aspects of the invention is to prevent a post-rewrite image from being affected by a pre-rewrite image.

A control device according to an aspect of the invention is a control device for an electro-optical apparatus, the apparatus including a first electrode provided for each of a plurality of pixels, a second electrode disposed facing the first electrodes, and a bi-stable electro-optical material interposed between the first electrodes and the second electrode, and the control device including a gray level control unit that rewrites an image displayed by the pixels in an image rewrite period having an adjustment phase; here, the adjustment phase is a phase that changes gray levels of the pixels from a half gray level or a predetermined one base gray level to a predetermined other base gray level over a plurality of frames, and in the adjustment phase, the gray level control unit applies a voltage that changes the gray levels of the pixels toward the other base gray level to the first electrodes for a number of application times based on a gray level difference between the pre-change gray levels of the pixels and the other base gray level, and applies the voltage for a higher number of application times and begins the voltage application at an earlier frame the greater the gray level difference is. Widely speaking, bi-stable display technic is growing with more and more displaying gray scale/color depth, i.e. multi-stable display technic. As already indicated, the gray levels need not be black and white. For example, one extreme optical state can be white and the other dark blue, so that the intermediate gray levels will be varying shades of blue, or one extreme optical state can be red and the other blue, so that the intermediate gray levels will be varying shades of purple.

According to this configuration, the gray levels of all of the pixels are aligned in the adjustment phase, and thus when changing the gray levels on a pixel-by-pixel basis, the gray level control is started from the same frame for all of the pixels; as a result, the post-rewrite image can be prevented from being affected by the pre-rewrite image.

In the control device, the image rewrite period may include a gray level control phase that follows the adjustment phase and in which a voltage for changing the gray levels of the pixels is applied to the first electrodes based on image data and the gray levels of the pixels are changed over a plurality of frames, and the gray level control unit may start the application of the voltage for changing the gray level at the same frame for pixels whose gray levels are to be changed from the gray levels present at the start of the gray level control phase.

According to this configuration, the gray levels of all of the pixels are aligned in the adjustment phase, and thus when changing the gray levels, the gray level control is started from the same frame for all of the pixels; as a result, the post-rewrite image can be prevented from being affected by the pre-rewrite image.

Furthermore, in the control device, the gray level control unit may apply the voltage to the first electrodes consecutively for the application times in the adjustment phase and the gray level control phase.

According to this configuration, the voltage can be applied consecutively to the electro-optical material, which makes it possible to minimize the effect of variations in the behavior of the electro-optical material immediately after the voltage application and immediately after the end of the voltage application.

Further still, in the control device, the image rewrite period may include a clearing phase that is provided between the adjustment phase and the gray level control phase and that changes the plurality of pixels to the one base gray level at least once and changes the pixels to the other base gray level at least once.

According to this configuration, the gray levels of the pixels are changed from the one base gray level to the other base gray level and the electro-optical material is agitated, and thus a ghost of the pre-rewrite image can be cleared.

Here, the electro-optical material may be electrophoretic particles, and the gray level control unit may apply a voltage that stops movement of the electrophoretic particles to the first electrodes at the end of at least gray level of the adjustment phase, the clearing phase, and the gray level control phase.

According to this configuration, the application of the voltage to the first electrodes begins with the electrophoretic particles in a resting state, which makes it possible to suppress variations in the behavior of the electro-optical material.

Further still, in the control device, the gray level control unit may set the polarity of the voltage applied to the first electrodes to one polarity until the pixels change to the one base gray level and may set the polarity of the voltage applied to the first electrodes to another polarity until the pixels change to the other base gray level.

According to this configuration, the direction toward which the gray levels of the pixels are changed takes on a specific direction, and thus the gray levels of all of the pixels can be aligned in a shorter amount of time in the adjustment phase of the next instance of driving.

A control device according to another aspect of the invention is a control device for an electro-optical apparatus, the apparatus including a first electrode provided for each of a plurality of pixels, a second electrode disposed facing the first electrodes, and a bi-stable electro-optical material interposed between the first electrodes and the second electrode, and the control device including a gray level control unit that rewrites an image displayed by the pixels in an image rewrite period having an adjustment phase; here, the adjustment phase is a phase that changes gray levels of the pixels from a half gray level or a predetermined one base gray level to a predetermined other base gray level in a predetermined period, and in the adjustment phase, the gray level control unit applies a voltage that changes the gray levels of the pixels toward the other base gray level to the first electrodes for an application time based on a gray level difference between the pre-change gray levels of the pixels and the other base gray level, and applies the voltage for a longer application time and begins the voltage application earlier the greater the gray level difference is.

According to this configuration, the gray levels of all of the pixels are aligned in the adjustment phase, and thus when changing the gray levels on a pixel-by-pixel basis, the gray level control is started from the same frame for all of the pixels; as a result, the post-rewrite image can be prevented from being affected by the pre-rewrite image.

An electro-optical apparatus according to another aspect of the invention has a first electrode provided for each of a plurality of pixels, a second electrode disposed facing the first electrodes, and a bi-stable electro-optical material interposed between the first electrodes and the second electrode, and includes a gray level control unit that rewrites an image displayed by the pixels in an image rewrite period having an adjustment phase; here, the adjustment phase is a phase that changes gray levels of the pixels from a half gray level or a predetermined one base gray level to a predetermined other base gray level over a plurality of frames, and in the adjustment phase, the gray level control unit applies a voltage that changes the gray levels of the pixels toward the other base gray level to the first electrodes for a number of application times based on a gray level difference between the pre-change gray levels of the pixels and the other base gray level, and applies the voltage for a higher number of application times and begins the voltage application at an earlier frame the greater the gray level difference is.

According to this configuration, the gray levels of all of the pixels are aligned in the adjustment phase, and thus when changing the gray levels on a pixel-by-pixel basis, the gray level control is started from the same frame for all of the pixels; as a result, the post-rewrite image can be prevented from being affected by the pre-rewrite image.

Note that the invention can be conceived of not only as a control device and an electro-optical apparatus, but also as a control method for an electro-optical apparatus and an electronic device that includes the electro-optical apparatus.

### BRIEF DESCRIPTION OF THE DRAWINGS

The invention will be described with reference to the accompanying drawings, wherein like numbers reference like elements.

FIG. 1 is a diagram illustrating the hardware configuration of a display device 1000.

FIG. 2 is a diagram illustrating a cross-section of a display region 100.

FIG. 3 is a diagram illustrating an equivalent circuit of a pixel 110.

FIG. 4 is a diagram illustrating the configuration of a controller 5.

FIGS. 5A to 5C are diagrams illustrating the configuration of a storage region.

FIGS. 6A and 6B are diagrams illustrating an example of a table in an LUT 503 according to a first embodiment.

FIGS. 7A and 7B are diagrams illustrating operations according to the first embodiment.

FIGS. 8A and 8B are diagrams illustrating operations according to the first embodiment.

FIGS. 9A and 9B are diagrams illustrating an example of a table in an LUT 503 according to a second embodiment.

FIGS. 10A and 10B are diagrams illustrating operations according to the second embodiment.

FIGS. 11A and 11B are diagrams illustrating operations according to the second embodiment.

FIG. 12 shows an external view of an e-book reader 2000.

### DESCRIPTION OF EXEMPLARY EMBODIMENTS

### First Embodiment

### Configuration of First Embodiment

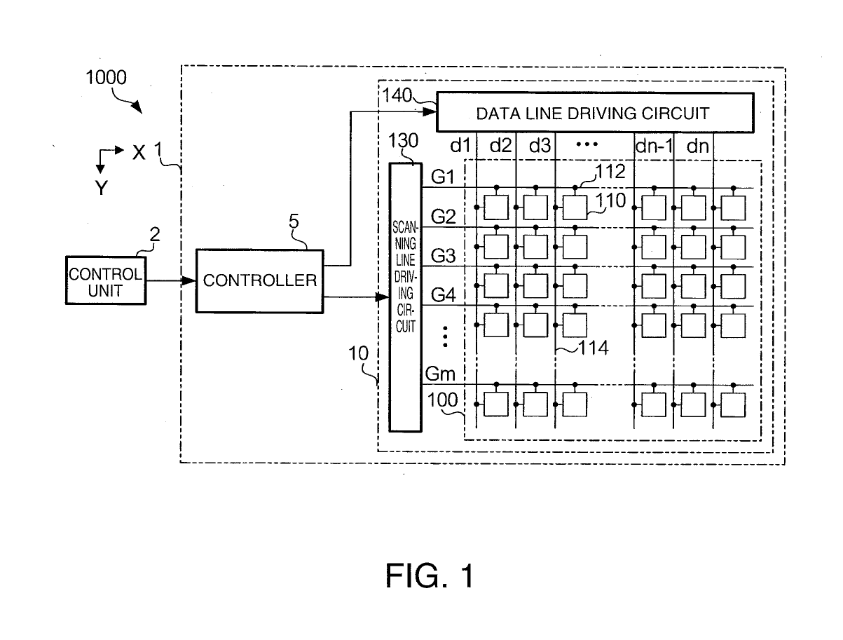

FIG. 1 is a block diagram illustrating the hardware configuration of a display device 1000 according to a first embodiment of the invention. The display device 1000 is a device that displays images, and includes an electrophoretic electro-optical apparatus 1 and a control unit 2. The electro-optical apparatus 1, meanwhile, includes a display unit 10 and a controller 5.

The control unit 2 is a microcomputer having a CPU (central processing unit), a ROM (read-only memory), a RAM, and the like, and controls the controller 5. The control unit 2 furthermore obtains image data expressing an image to be displayed in a display region 100 from a recording medium (not shown) and supplies the image data to the controller 5.

The controller 5 supplies various types of signals for causing an image to be displayed in the display region 100 of the display unit 10 to a scanning line driving circuit 130 and a data line driving circuit 140 in the display unit 10. The controller 5 corresponds to a control device of the electro-optical apparatus 1. Note that it is also possible to collectively define the control unit 2 and the controller 5 as the control device of the electro-optical apparatus 1.

In the display region 100, a plurality of scanning lines 112 are provided along the row (X) direction in FIG. 1, and a plurality of data lines 114 are provided along the column (Y) direction, with the data lines 114 electrically insulated from the scanning lines 112. A pixel 110 is provided at each intersection between a scanning line 112 and a data line 114. When, for the sake of simplicity, a row number of the scanning lines 112 is represented by “m” and a column number of the data lines 114 is represented by “n”, the pixels 110 are arranged in a matrix, having m rows on the vertical and n columns on the horizontal, that configures the display region 100.

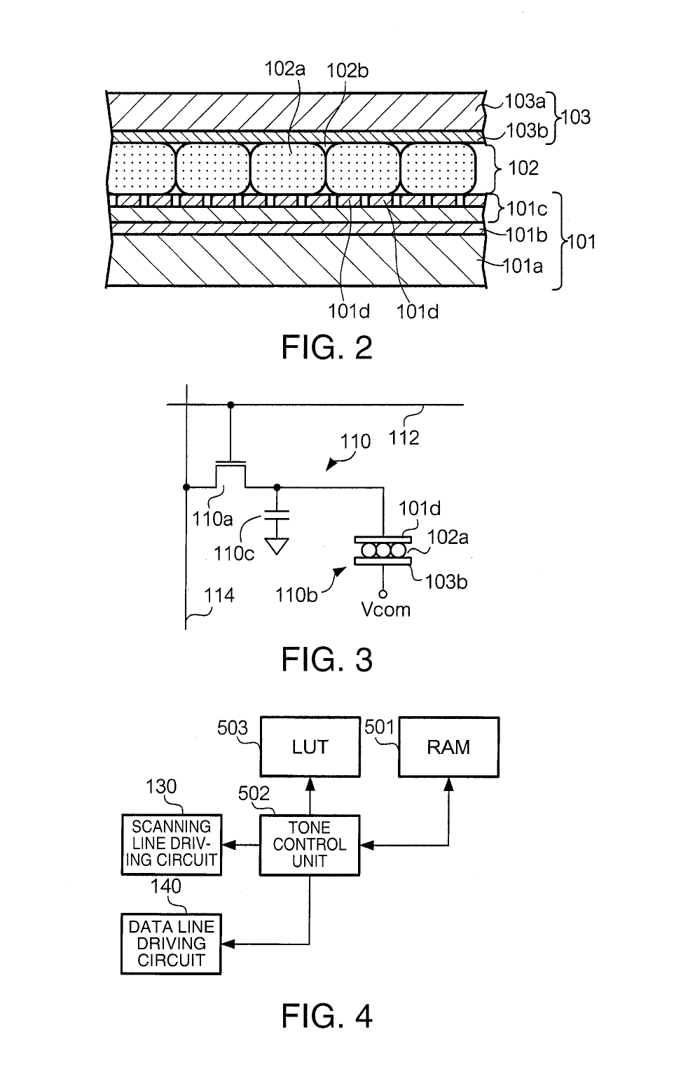

FIG. 2 is a diagram illustrating a cross-section of the display region 100. As shown in FIG. 2, the display region 100 is generally configured of a first substrate 101, an electrophoretic layer 102, and a second substrate 103. The first substrate 101 is a substrate in which a circuit layer is formed upon an insulative, flexible substrate 101a. In this embodiment, the substrate 101a is formed of a polycarbonate. Note, however, that the substrate 101a is not limited to a polycarbonate, and a lightweight, flexible, elastic, and insulative resin material can also be used. The substrate 101a may also be formed from glass, which is not flexible. An adhesive layer 101b is provided on a surface of the substrate 101a, and a circuit layer 101c is layered upon the surface of the adhesive layer 101b,

The circuit layer 101c includes the plurality of scanning lines 112 arranged in the row direction and the plurality of data lines 114 arranged in the column direction. In addition, the circuit layer 101c includes pixel electrodes 101d (first electrodes) corresponding to each intersection between the scanning lines 112 and the data lines 114.

The electrophoretic layer 102, which is an example of an electro-optical material, is configured of a binder 102b and a plurality of microcapsules 102a fixed by the binder 102b, and is formed upon the pixel electrodes 101d. An adhesive layer formed of an adhesive may be provided between the microcapsules 102a and the pixel electrodes 101d.

The binder 102b is not particularly limited as long as it is a material having good compatibility with the microcapsules 102a, superior adhesiveness with electrodes, and is insulative. A carrier fluid and electrophoretic particles are held within each microcapsule 102a. It is preferable to use a flexible material as the material that configures the microcapsules 102a, such as a gum Arabic/gelatin-based compound, a urethane-based compound, or the like.

Water, alcohol solvents (methanol, ethanol, isopropanol, butanol, octanol, methyl cellosolve, and so on), esters (ethyl acetate, butyl acetate, and so on), kegray levels (acegray level, methyl ethyl kegray level, methyl isobutyl kegray level, and so on), aliphatic hydrocarbons (pentane, hexane, octane, and so on), alicyclic hydrocarbons (cyclo hexane, methyl cyclo hexane, and so on), aromatic hydrocarbons (benzene, toluene, benzenes having long-chain alkyl bases (xylene, hexyl benzene, heptyl benzene, octyl benzene, nonyl benzene, decyl benzene, undecyl benzene, dodecyl benzene, tridecyl benzene and tetradecyl benzene)), halogenated hydrocarbons (methylene chloride, chloroform, carbon tetrachloride, 1,2-dichloroethane, and so on), carboxylic acid salt, and so on can be given as examples of the carrier fluid; other oils may be employed as well. These materials may be used alone or as mixtures for the carrier fluid, and surface-active agents may be added thereto and used as the carrier fluid as well.

The electrophoretic particles are particles (high-polymers or colloids) having a property whereby the particles move within the carrier fluid under an electrical field. In this embodiment, white electrophoretic particles and black electrophoretic particles are held within each microcapsule 102a. The black electrophoretic particles are particles configured of a black pigment such as aniline black, carbon black, or the like, and in this embodiment, are positively charged. The white electrophoretic particles, meanwhile, are particles configured of a white pigment such as titanium dioxide, aluminum oxide, or the like, and in this embodiment, are negatively charged.

The second substrate 103 is configured of a film 103a and a transparent common electrode layer 103b (a second electrode) formed upon a bottom surface of the film 103a. The film 103a serves to seal and protect the electrophoretic layer 102, and is a polyethlene terephthalate film, for example. The film 103a is transparent and insulative. The common electrode layer 103b is configured of a transparent conductive film such as an indium tin oxide (ITO) film.

FIG. 3 is a diagram illustrating an equivalent circuit of the pixel 110. Note that in this embodiment, the scanning lines 112 shown in FIG. 1 may be referred to as being in the first, second, third, . . . , (m−1)th, and mth row from the top, in order to distinguish between respective scanning lines 112. Likewise, the data lines 114 shown in FIG. 1 may be referred to as being in the first, second, third, . . . , (n−1)th, and nth column from the left, in order to distinguish between respective data lines 114.

FIG. 3 illustrates an equivalent circuit in a pixel 110 at the intersection of the scanning line 112 in an ith row and the data line 114 in a jth column. The pixels 110 at the intersections of the other data lines 114 and scanning lines 112 have the same configurations as that shown in FIG. 3, and thus the equivalent circuit in the pixel 110 at the intersection of the scanning line 112 in the ith row and the data line 114 in the jth column will be described here as a representative example, with descriptions of the equivalent circuits of the other pixels 110 being omitted.

As shown in FIG. 3, each pixel 110 includes an re-channel thin-film transistor (“TFT” hereinafter, for brevity) 110a, a display element 110b, and an auxiliary capacitor 110c. In the pixel 110, a gate electrode of the TFT 110a is connected to the scanning line 112 in the ith row, a source electrode is connected to the data line 114 in the jth column, and a drain electrode is connected to the pixel electrode 101d on one end of the display element 110b and to one end of the auxiliary capacitor 110c. The auxiliary capacitor 110c is configured by interposing a dielectric layer between a pair of electrodes formed in the circuit layer 101c. An electrode at the other end of the auxiliary capacitor 110c is set to a voltage common for all of the pixels 110. The pixel electrode 101d opposes the common electrode layer 103b, and the electrophoretic layer 102 containing the microcapsules 102a is interposed between the pixel electrode 101d and the common electrode layer 103b. Accordingly, the display element 110b is, when viewed as an equivalent circuit, a capacitor that holds the electrophoretic layer 102 between the pixel electrode 101d and the common electrode layer 103b. The display element 110b holds (stores) a voltage between the two electrodes, and performs displays in accordance with the direction of an electrical field produced by the held voltage. Note that in this embodiment, an external circuit (not shown) applies a common voltage Vcom to the electrode at the other end of the auxiliary capacitor 110c and as the voltage for the common electrode layer 103b in each pixel 110.

Returning to FIG. 1, the scanning line driving circuit 130 is connected to each scanning line 112 in the display region 100. Under the control of the controller 5, the scanning line driving circuit 130 selects the scanning lines 112 in the first, second, and so on up to the mth rows in that order, supplies a high-level signal to the selected scanning line 112, and supplies low-level signals to the other unselected scanning lines 112.

The data line driving circuit 140 is connected to each data line 114 in the display region, and obtains, from the controller 5, data indicating voltages to be applied to the pixel electrodes 101d of the pixels 110 connected to the selected scanning line 112. The data line driving circuit 140 supplies data signals to the data lines 114 in each column based on the obtained data.

During a period from when the scanning line driving circuit 130 selects the scanning line 112 in the first row to when the scanning line driving circuit 130 selects the scanning line 112 in the mth row (called a “frame period” or simply a “frame” hereinafter), the scanning lines 112 are selected one at a time, and data signals are supplied to the pixels 110 one at a time in a single frame.

When a scanning line 112 goes to high-level, the TFTs 110a whose gates are connected to that scanning line 112 turn on, and the pixel electrodes 101d are connected to the data lines 114. When the scanning line 112 is at high-level and the data signals are supplied to the data lines 114, the data signals are applied to the pixel electrodes 101d via the TFTs 110a that are on. When the scanning line 112 then goes to low-level, the TFTs 110a turn off, but the voltages applied to the pixel electrodes 101d by the data signals are stored in the auxiliary capacitors 110c, and the electrophoretic particles move under potential differences (voltages) between the potentials of the pixel electrodes 101d and the potential of the common electrode layer 103b.

For example, in the case where the voltage applied to the pixel electrode 101d is +15 V relative to the voltage Vcom applied to the common electrode layer 103b, the negatively-charged white electrophoretic particles move toward the pixel electrode 101d, the positively-charged black electrophoretic particles move toward the common electrode layer 103b, and the pixel 110 displays black. Likewise, in the case where the voltage applied to the pixel electrode 101d is −15 V relative to the voltage Vcom applied to the common electrode layer 103b, the positively-charged black electrophoretic particles move toward the pixel electrode 101d, the negatively-charged white electrophoretic particles move toward the common electrode layer 103b, and the pixel 110 displays white. Note that the voltage of the pixel electrode 101d is not limited to the aforementioned voltage, and voltages aside from the aforementioned +15 V and −15 V may be used as long as the voltages are positive or negative relative to the voltage Vcom of the common electrode layer 103b.

In this embodiment, when changing the display state of the pixels 110, the display state is changed by supplying data signals to the pixels 110 over a plurality of frames, rather than changing the display state by supplying data signals to the pixels 110 for only a single frame. For example, when changing the display state of the pixel 110 from white (W) to black (B), data signals for causing the pixel 110 to display black are supplied to the pixel 110 over a plurality of frames, whereas when changing the display state of the pixel 110 from black to white, data signals for causing the pixel 110 to display white are supplied to the pixel 110 over a plurality of frames. Using a phenomenon in which a pixel will not turn black or white if a potential difference is applied to the electrophoretic particles for only a single frame, dark gray (DG) and light gray (LG) displays are performed in this embodiment by controlling the number of times the +15 V or −15 V voltage is applied to the pixel electrode 101d.

In addition, in this embodiment, the pixel electrode 101d of a given pixel 110 can be set to a positive polarity in a single frame so that the potential thereof is higher than the common electrode layer 103b, and the pixel electrode 101d of another pixel 110 can be set to a negative polarity in the same frame so that the potential thereof is lower than the common electrode layer 103b. In other words, the driving performed enables both positive and negative polarities to be selected relative to the common electrode layer 103b in a single frame (this will be called “bipolar driving” hereinafter). To be more specific, in a single frame, the pixel electrode 101d of a pixel 110 whose gray level is to be changed toward a high gray level value is set to a negative polarity, whereas the pixel electrode 101d of a pixel 110 whose gray level is to be changed toward a low gray level value is set to a positive polarity. Note that in the case where the black electrophoretic particles are negatively-charged and the white electrophoretic particles are positively-charged, the pixel electrode 101d of the pixel 110 whose gray level value is to be changed toward a high gray level value may be set to a positive polarity and the pixel electrode 101d of the pixel 110 whose gray level value is to be changed toward a low gray level value may be set to a negative polarity.

Next, the configuration of the controller 5 will be described. FIG. 4 is a block diagram illustrating the configuration of the controller 5 according to this embodiment. The controller 5 includes a RAM 501, a gray level control unit 502, and an LUT 503.

The RAM 501 is provided with a storage region that stores frame numbers managing what number frame is being controlled in each of respective phases, which will be described later.

Furthermore, the RAM 501 is provided with a first storage region that stores image data supplied by the control unit 2 and a second storage region that stores image data of a displayed image. Each storage region has its own storage region (buffer) for each of the pixels 110 arranged in m rows by n columns. The image data contains pixel data expressing the gray level of each pixel 110, and the pixel data expressing the gray level of a single pixel 110 is stored in a single storage region in the RAM 501 corresponding to that pixel 110. Note that when the display of an image corresponding to the image data stored in the first storage region ends, the image data stored in the second storage region is overwritten with the image data that had been stored in the first storage region.

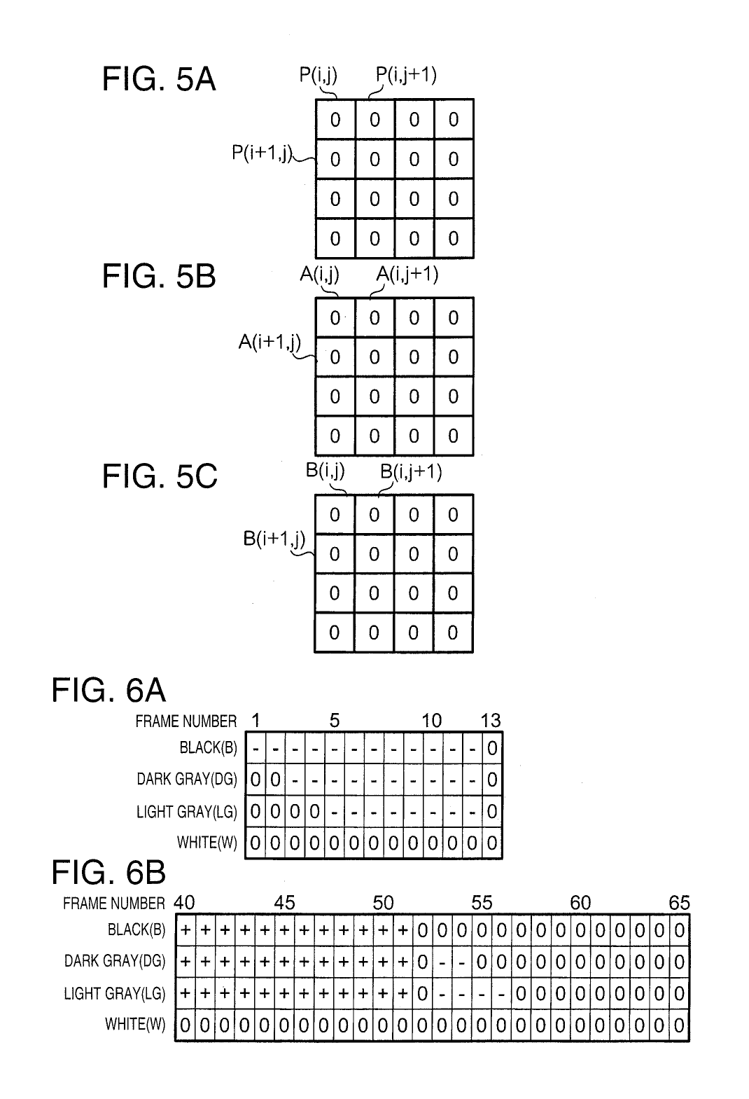

FIGS. 5A to 5C are diagrams illustrating some of the pixels 110 in the display region 100 along with each storage region that corresponds to those pixels 110. FIG. 5A is a diagram illustrating the arrangement of the pixels 110. A pixel P(i,j) indicates a single pixel 110 in the ith row and the jth column. The letter i indicates the row numbers and the letter j indicates the column numbers of the pixels 110 arranged in rows and columns. FIG. 5B is a diagram illustrating buffers in the first storage region that correspond to the respective pixels 110 shown in FIG. 5A, whereas FIG. 5C is a diagram illustrating buffers in the second storage region that correspond to the respective pixels 110 shown in FIG. 5A.

For example, a buffer A(i,j) in the first storage region is a storage region corresponding to the pixel P(i,j). Pixel data indicating the gray level to be displayed by the pixel P(i,j) is written into the buffer A(i,j). Note that pixel data whose value is “0” is written in the case where the pixel 110 is to be set to black, whereas pixel data whose value is “3” is written in the case where the pixel 110 is to be set to white. Likewise, pixel data whose value is “1” is written in the case where the pixel 110 is to be set to dark gray, whereas pixel data whose value is “2” is written in the case where the pixel 110 is to be set to light gray. Meanwhile, a buffer B(i,j) in the second storage region is a storage region corresponding to the pixel P(i,j). Pixel data indicating the gray level that was displayed by the pixel P(i,j) is written into the buffer B(i,j).

Note that the RAM 501 is not limited to being incorporated into the controller 5, and may be provided externally.

The LUT 503 is a lookup table that stores voltages to be applied to the pixel electrodes 101d in a frame period when a displayed image is rewritten. When the gray level control unit 502 inputs new gray levels to be newly displayed due to a rewrite (that is, the pixel data stored in the first storage region), old gray levels displayed prior to the rewrite (that is, the pixel data stored in the second storage region), frame numbers, or the like into the LUT 503, the LUT 503 outputs voltages to be applied to the pixel electrodes 101d in the frame corresponding to the inputted frame number to the gray level control unit 502.

The gray level control unit 502 is a block that controls the gray levels of the pixels 110. The gray level control unit 502 controls the gray levels of the pixels 110 by controlling the scanning line driving circuit 130 and the data line driving circuit 140 to apply the +15 V voltage or the −15 V voltage to the pixel electrodes 101d during the frame period. Specifically, in this embodiment, the gray level control unit 502 rewrites images using an adjustment phase, a clearing phase, and a gray level control phase during a rewrite period in which the image is rewritten.

The adjustment phase is a phase in which all of the pixels 110 are set to the same gray level when rewriting an image. In this embodiment, the gray levels of all of the pixels 110 are set to white in the adjustment phase. In this embodiment, there are 13 frames in the adjustment phase. In other words, in the case where the number of the first frame when rewriting the image is 1, the first to 13th frames correspond to the adjustment phase.

The clearing phase is a phase in which ghosts remaining in the display region 100 are cleared following the adjustment phase. In the clearing phase, the gray levels of all of the pixels 110 set to white in the adjustment phase are set to black and then once again set to white. In this embodiment, there are 26 frames in the clearing phase. In the case where the number of the first frame when rewriting the image is 1, the 14th to 39th frames correspond to the clearing phase.

The gray level control phase is a phase in which the gray levels of the pixels 110 are controlled after the clearing phase. In the gray level control phase, the gray levels of the pixels 110 are controlled in accordance with the pixel data stored in the first storage region. In this embodiment, there are 26 frames in the gray level control phase. In the case where the number of the first frame when rewriting the image is 1, the 40th to 65th frames correspond to the gray level control phase.

Example of Operations in First Embodiment

Next, an example of operations performed when rewriting the gray levels of pixels according to the first embodiment will be described. Note that in the following descriptions, a pixel A corresponds to a pixel P(1,1), a pixel B corresponds to a pixel P(1,2), a pixel C corresponds to a pixel P(1,3), and a pixel D corresponds to a pixel P(1,4); furthermore, the following describes operations performed when the pixel A is black, the pixel B is dark gray, the pixel C is light gray, and the pixel D is white prior to the rewrite and the pixel A is rewritten to white, the pixel B is rewritten to light gray, the pixel C is rewritten to dark gray, and the pixel D is rewritten to black.

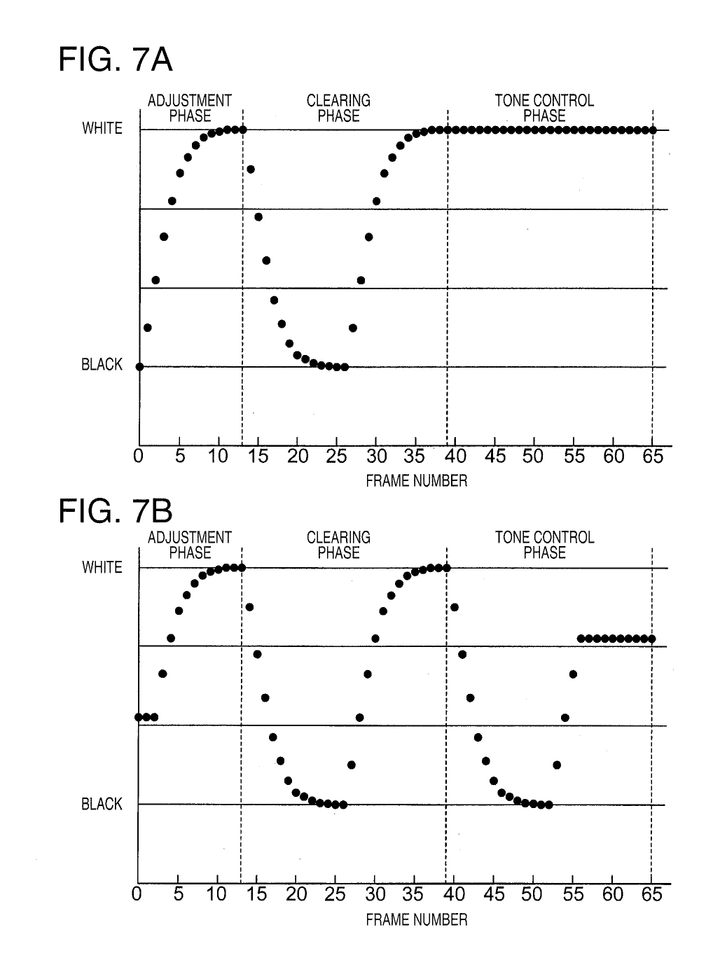

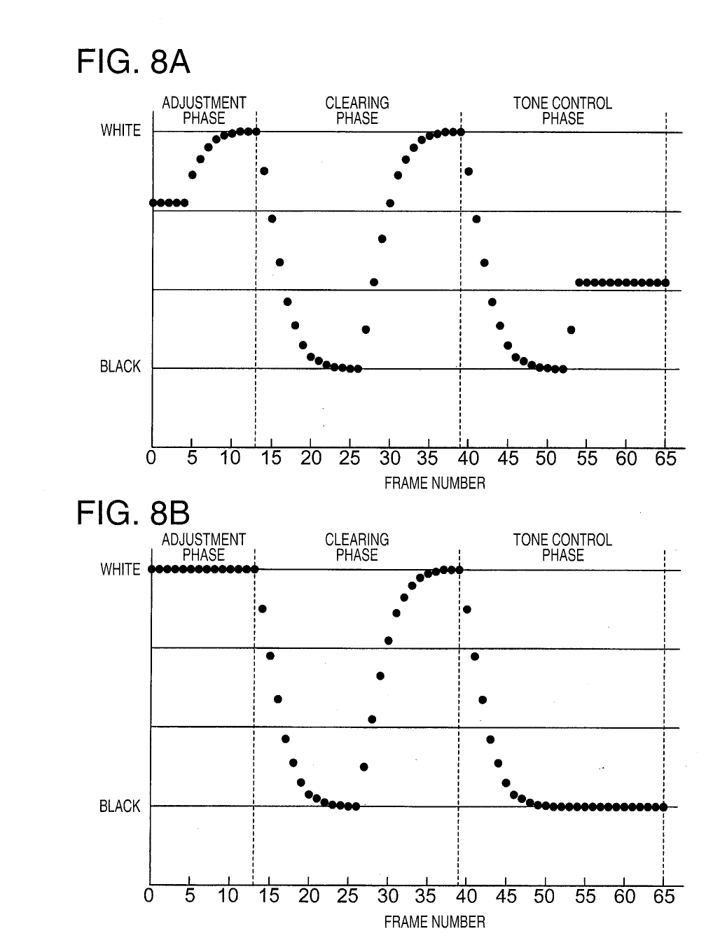

FIGS. 6A and 6B are diagrams illustrating an example of a table stored in the LUT 503, and FIGS. 7A and 7B are diagrams illustrating shifts in the gray levels of the pixels A through D in each phase. In FIGS. 6A and 6B, “+” indicates that the +15 V voltage is applied to the pixel electrode 101d, whereas “−” indicates that the −15 V voltage is applied to the pixel electrode 101d. Note that “0” indicates that the voltage Vcom is applied to the pixel electrode 101d and the potential difference between the pixel electrode 101d and the common electrode layer 103b is set to 0 V. Meanwhile, in FIGS. 7A and 7B, the horizontal axis represents the frame number, and the vertical axis represents the brightness (gray level) of the pixel. FIG. 7A is a diagram illustrating a shift in the gray level of the pixel A, whereas FIG. 7B is a diagram illustrating a shift in the gray level of the pixel B. Meanwhile, FIG. 8A is a diagram illustrating a shift in the gray level of the pixel C, whereas FIG. 8B is a diagram illustrating a shift in the gray level of the pixel D.

In this embodiment, in FIG. 7A, the gray level is black (one base gray level) in frame number 0, the gray level is dark gray in frame number 2, the gray level is light gray in frame number 4, and the gray level is white (another base gray level) in frame number 12.

When the image in the display region 100 is to be rewritten, the control unit 2 outputs the image data to the controller 5. Upon obtaining the image data outputted by the control unit 2, the controller 5 writes the obtained image data into the first storage region of the RAM 501. Note that the image data of the image displayed before the new image data was obtained is written in the second storage region. When the new image data is written into the first storage region, the gray level control unit 502 starts the adjustment phase.

In the adjustment phase, first, to control the gray levels of the pixels 110 across a plurality of frames, the gray level control unit 502 resets the frame number managing what number frame is being controlled to 1. The gray level control unit 502 obtains the pixel data in the second storage region after the frame number has been reset.

Upon obtaining pixel data (0) of the pixel A from the second storage region, the gray level control unit 502 outputs the obtained pixel data and the frame number to the LUT 503. Upon obtaining the pixel data and the frame number, the LUT 503 outputs the voltage to be applied to the pixel electrode 101d of the pixel A in the frame corresponding to the obtained number. Here, assuming the obtained frame number is 1 and the value of the pixel data is 0 (black), the LUT 503 refers to the table indicated in FIG. 6A and outputs “−”, corresponding to a row in which the gray level is black and a column in which the frame number is 1, to the gray level control unit 502. Upon obtaining “−” as the voltage to be applied to the pixel electrode 101d of the pixel A, the gray level control unit 502 outputs, to the data line driving circuit 140, a signal specifying −15 V as the voltage applied to the pixel electrode 101d of the pixel A.

When the data line driving circuit 140 then outputs a data signal to the data line 114 based on the signal in the first frame, the −15 V voltage is applied to the pixel electrode 101d of the pixel A, and the gray level of the pixel A approaches white in the first frame, as indicated in FIG. 7A.

Likewise, upon obtaining pixel data (1) of the pixel B from the second storage region, the gray level control unit 502 outputs the obtained pixel data and the frame number to the LUT 503. Here, because the obtained frame number is 1 and the value of the pixel data is 1 (dark gray), the LUT 503 refers to the table indicated in FIG. 6A and outputs “0”, corresponding to a row in which the gray level is dark gray and the column in which the frame number is 1, to the gray level control unit 502. Upon obtaining “0” as the voltage to be applied to the pixel electrode 101d of the pixel B, the gray level control unit 502 outputs, to the data line driving circuit 140, a signal specifying the voltage Vcom as the voltage applied to the pixel electrode 101d of the pixel B. When the data line driving circuit 140 then outputs a data signal to the data line 114 based on the signal in the first frame, the voltage Vcom is applied to the pixel electrode 101d of the pixel B, and the gray level of the pixel B does not change from the pre-rewrite state in the first frame, as indicated in FIG. 7B.

Furthermore, upon obtaining pixel data (2) of the pixel C from the second storage region, the gray level control unit 502 outputs the obtained pixel data and the frame number to the LUT 503. Here, because the obtained frame number is 1 and the value of the pixel data is 2 (light gray), the LUT 503 refers to the table indicated in FIG. 6A and outputs “0”, corresponding to a row in which the gray level is light gray and the column in which the frame number is 1, to the gray level control unit 502. Upon obtaining “0” as the voltage to be applied to the pixel electrode 101d of the pixel C, the gray level control unit 502 outputs, to the data line driving circuit 140, a signal specifying the voltage Vcom as the voltage applied to the pixel electrode 101d of the pixel C. When the data line driving circuit 140 then outputs a data signal to the data line 114 based on the signal in the first frame, the voltage Vcom is applied to the pixel electrode 101d of the pixel C, and the gray level of the pixel C does not change from the pre-rewrite state in the first frame, as indicated in FIG. 8A.

Furthermore, upon obtaining pixel data (3) of the pixel D from the second storage region, the gray level control unit 502 outputs the obtained pixel data and the frame number to the LUT 503. Here, because the obtained frame number is 1 and the value of the pixel data is 3 (white), the LUT 503 refers to the table indicated in FIG. 6A and outputs “0”, corresponding to a row in which the gray level is white and the column in which the frame number is 1, to the gray level control unit 502. Upon obtaining “0” as the voltage to be applied to the pixel electrode 101d of the pixel D, the gray level control unit 502 outputs, to the data line driving circuit 140, a signal specifying the voltage Vcom as the voltage applied to the pixel electrode 101d of the pixel D. When the data line driving circuit 140 then outputs a data signal to the data line 114 based on the signal in the first frame, the voltage Vcom is applied to the pixel electrode 101d of the pixel D, and the gray level of the pixel D does not change from the pre-rewrite state in the first frame, as indicated in FIG. 8B.

The gray level control unit 502 adds 1 to the frame number, obtains the voltage to be applied to the pixel electrode 101d in the following frame from the LUT 503, and controls the gray level of the pixel 110 each time a frame period ends, until the gray level control phase ends. Because the gray level of the pixel A is black prior to the rewrite, the −15 V voltage is applied to the pixel electrode 101d from the second frame to the 12th frame, as indicated in FIG. 6A. Accordingly, as indicated in FIG. 7A, in the adjustment phase, the gray level of the pixel A approaches white and becomes white in the 12th frame.

Likewise, because the gray level of the pixel B is dark gray prior to the rewrite, the voltage Vcom is applied to the pixel electrode 101d up to the second frame and the −15 V voltage is applied to the pixel electrode 101d from the third frame to the 12th frame, as indicated in FIG. 6A. Accordingly, as indicated in FIG. 7B, in the adjustment phase, the gray level of the pixel B approaches white and becomes white in the 12th frame.

Furthermore, because the gray level of the pixel C is light gray prior to the rewrite, the voltage Vcom is applied to the pixel electrode 101d from the second frame to the fourth frame and the −15 V voltage is applied to the pixel electrode 101d from the fifth frame to the 12th frame, as indicated in FIG. 6A. Accordingly, as indicated in FIG. 8A, the gray level of the pixel C approaches white and becomes white in the 12th frame.

Finally, because the gray level of the pixel D is white prior to the rewrite, the voltage Vcom is applied to the pixel electrode 101d from the first frame to the 12th frame, as indicated in FIG. 6A. In other words, in the case where the gray level of the pixel 110 is white prior to the image rewrite, the gray level of that pixel 110 is not changed in the adjustment phase.

Note that the voltages of the pixel electrodes 101d for all of the pixels 110 are set to the voltage Vcom in the 13th frame, which is the final frame of the adjustment phase.

In this manner, in the adjustment phase, the timings at which the respective pixels reach a white display can be aligned by varying the frame in which the −15 V voltage is applied to the pixel electrode 101d from pixel to pixel. In this embodiment, all of the pixels reach a white display in the 12th frame, aside from the pixels that were originally displaying white. Doing so makes it possible to align the behavior of the electrophoretic particles from pixel to pixel in the 12th frame. As a result, the behavior of the electrophoretic particles from pixel to pixel can be aligned in the following phases as well, which in turn makes it possible to prevent variations in the display brightness.

When the adjustment phase ends, the gray level control unit 502 then starts the clearing phase. In the clearing phase, the +15 V voltage is applied to the pixel electrodes 101d of all of the pixels 110 from the 14th frame to the 25th frame. Accordingly, the gray levels of the pixels A through D approach black from the 14th frame and become black in the 25th frame, as indicated in FIGS. 7A to 8B. Note that the voltages of the pixel electrodes 101d for all of the pixels 110 are set to the voltage Vcom in the 26th frame. Furthermore, in the clearing phase, the −15 V voltage is applied to the pixel electrodes 101d of all of the pixels 110 from the 27th frame to the 38th frame. Accordingly, the gray levels of the pixels A through D approach white from the 27th frame and become white in the 38th frame, as indicated in FIGS. 7A to 8B. Note that the voltages of the pixel electrodes 101d for all of the pixels 110 are set to the voltage Vcom in the 39th frame.

In this manner, shifting the gray levels of all of the pixels 110 from white, to black, and to white again in the clearing phase agitates the white and black electrophoretic particles and clears a ghost of the pre-rewrite image.

When the clearing phase ends, the gray level control unit 502 starts the gray level control phase. First, the gray level control unit 502 obtains the pixel data in the first storage region. Upon obtaining pixel data (3) of the pixel A from the first storage region, the gray level control unit 502 outputs the obtained pixel data and the frame number at the start of the gray level control phase (here, frame number 40) to the LUT 503. Upon obtaining the pixel data and the frame number, the LUT 503 outputs the voltage to be applied to the pixel electrode 101d in the frame corresponding to the obtained number.

Here, because the obtained frame number is 40 and the value of the pixel data is 3 (white), the LUT 503 refers to the table indicated in FIG. 6B and outputs “0”, corresponding to a row in which the gray level is white and a column in which the frame number is 40, to the gray level control unit 502. Upon obtaining “0” as the voltage to be applied to the pixel electrode 101d of the pixel A, the gray level control unit 502 outputs, to the data line driving circuit 140, a signal specifying the voltage Vcom as the voltage applied to the pixel electrode 101d of the pixel A. When the data line driving circuit 140 then outputs a data signal to the data line 114 based on the signal in the 40th frame, the voltage Vcom is applied to the pixel electrode 101d of the pixel A, and the gray level of the pixel A does not change in the 40th frame, as indicated in FIG. 7A.

Likewise, upon obtaining pixel data (2) of the pixel B from the first storage region, the gray level control unit 502 outputs the obtained pixel data and the frame number to the LUT 503. Here, in the case where the obtained frame number is 40 and the value of the pixel data is 2 (light gray), the LUT 503 refers to the table indicated in FIG. 6B and outputs “+”, corresponding to a row in which the gray level is light gray and the column in which the frame number is 40, to the gray level control unit 502. Upon obtaining “+” as the voltage to be applied to the pixel electrode 101d of the pixel B, the gray level control unit 502 outputs, to the data line driving circuit 140, a signal specifying the +15 V voltage as the voltage applied to the pixel electrode 101d of the pixel B. When the data line driving circuit 140 then outputs a data signal to the data line 114 based on the signal in the 40th frame, the +15 V voltage is applied to the pixel electrode 101d of the pixel B, and the gray level of the pixel B approaches black from white in the 40th frame, as indicated in FIG. 7B.

Furthermore, upon obtaining pixel data (1) of the pixel C from the first storage region, the gray level control unit 502 outputs the obtained pixel data and the frame number to the LUT 503. Here, in the case where the obtained frame number is 40 and the value of the pixel data is 1 (dark gray), the LUT 503 refers to the table indicated in FIG. 6B and outputs “+”, corresponding to a row in which the gray level is dark gray and the column in which the frame number is 40, to the gray level control unit 502. Upon obtaining “+” as the voltage to be applied to the pixel electrode 101d of the pixel C, the gray level control unit 502 outputs, to the data line driving circuit 140, a signal specifying the +15 V voltage as the voltage applied to the pixel electrode 101d of the pixel C. When the data line driving circuit 140 then outputs a data signal to the data line 114 based on the signal in the 40th frame, the +15 V voltage is applied to the pixel electrode 101d of the pixel C, and the gray level of the pixel C approaches black from white in the 40th frame, as indicated in FIG. 8A.

Furthermore, upon obtaining pixel data (0) of the pixel D from the first storage region, the gray level control unit 502 outputs the obtained pixel data and the frame number to the LUT 503. Here, in the case where the obtained frame number is 40 and the value of the pixel data is 0 (black), the LUT 503 refers to the table indicated in FIG. 6B and outputs “+”, corresponding to a row in which the gray level is black and the column in which the frame number is 40, to the gray level control unit 502. Upon obtaining “+” as the voltage to be applied to the pixel electrode 101d of the pixel D, the gray level control unit 502 outputs, to the data line driving circuit 140, a signal specifying the +15 V voltage as the voltage applied to the pixel electrode 101d of the pixel D. When the data line driving circuit 140 then outputs a data signal to the data line 114 based on the signal in the 40th frame, the +15 V voltage is applied to the pixel electrode 101d of the pixel D, and the gray level of the pixel D approaches black from white in the 40th frame, as indicated in FIG. 8B.

Thereafter, the gray level control unit 502 adds 1 to the frame number, obtains the voltage to be applied to the pixel electrode 101d in the following frame from the LUT 503, and controls the gray level of the pixel 110 each time a frame period ends.

For the pixel A that is set to white after the rewrite, the voltage Vcom is applied to the pixel electrode 101d from the 41st frame to the 51st frame, as indicated in FIG. 6B. As a result, the gray level of the pixel A remains white, without changing, from the 41st frame to the 51st frame, as indicated in FIG. 7A.

Meanwhile, for the pixels B through D that take on gray levels aside from white after the rewrite, the +15 V voltage is applied to the pixel electrodes 101d from the 41st frame to the 51st frame, as indicated in FIG. 6B. As a result, the gray levels of the pixels B through D become black in the 51st frame, as indicated in FIGS. 7B, 8A, and 8B. Note that the voltages of the pixel electrodes 101d for all of the pixels 110 are set to the voltage Vcom in the 52nd frame.

From the 53rd frame on, for the pixels A and D, the voltage Vcom is applied to the pixel electrodes 101d from the 53rd frame to the 64th frame, as indicated in FIG. 6B. As a result, from the 53rd frame to the 64th frame, the gray level of the pixel A remains white, without changing, from the 37th frame, as indicated in FIG. 7A, and the gray level of the pixel D remains black, without changing, from the 53rd frame, as indicated in FIG. 8B.

Meanwhile, for the pixel B that is set to light gray after the rewrite, the −15 V voltage is applied to the pixel electrode 101d from the 53rd frame to the 56th frame and the voltage Vcom is applied to the pixel electrode 101d from the 57th frame to the 64th frame, as indicated in FIG. 6B. As a result, the gray level approaches white in the 53rd frame, the gray level reaches light gray at the 56th frame, and the gray level remains light gray, without changing, from the 57th frame, as indicated in FIG. 7B.

Likewise, for the pixel C that is set to dark gray after the rewrite, the −15 V voltage is applied to the pixel electrode 101d in the 53rd frame and the 54th frame, and the voltage Vcom is applied to the pixel electrode 101d from the 55th frame to the 64th frame, as indicated in FIG. 6B. As a result, the gray level reaches dark gray in the 54th frame and remains dark gray, without changing, from the 55th frame, as indicated in FIG. 8A.

Note that the voltages of the pixel electrodes 101d for all of the pixels 110 are set to the voltage Vcom in the 65th frame.

As described thus far, according to this embodiment, the adjustment phase aligns the gray levels of all of the pixels 110, and thus in the gray level control phase, the gray level control can be started from the same frame for all of the pixels 110.

Furthermore, in this embodiment, the voltage Vcom is applied to the pixel electrodes 101d in all of the pixels 110 after the gray levels of all of the pixels 110 have been aligned. Due to this control, the electrophoretic particles are at rest when the gray level control phase starts, and thus the gray level control is carried out in a state where the electrophoretic particles in all of the pixels 110 have equal mobility; this in turn makes it difficult for gray level differences to arise between pixels 110 that are intended to display the same gray level.

Furthermore, according to this embodiment, when displaying light gray and dark gray, both gray levels are controlled by applying the −15 V voltage to the pixel electrodes 101d from a black state and varying the number of times the voltage is applied, which makes it difficult for variations to arise in the gray level difference between light gray and dark gray.

### Second Embodiment

Next, a second embodiment of the invention will be described. The second embodiment of the invention differs from the first embodiment in that the configuration of the LUT 503 and the clearing phase are different from those in the first embodiment. The following will omit descriptions of configurations that are the same as in the first embodiment, and will instead focus on the differences.

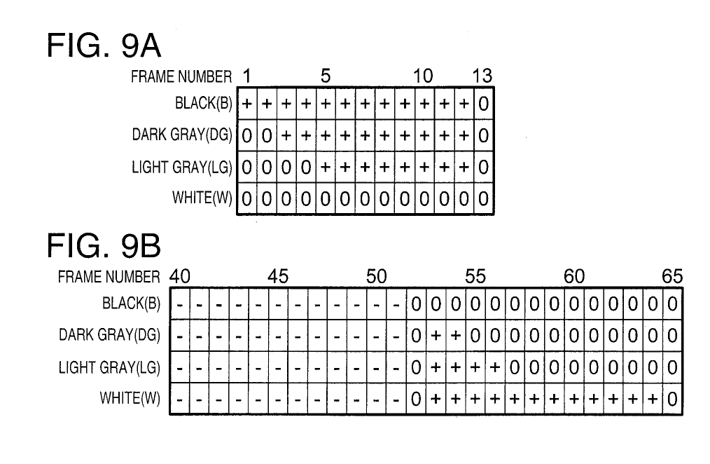

FIGS. 9A and 9B are tables stored in the LUT 503 according to this embodiment. FIG. 9A is a table that holds voltages applied to the pixel electrodes 101d in the adjustment phase according to the second embodiment, and FIG. 9B is a table holding voltages applied to the pixel electrodes 101d in the gray level control phase according to the second embodiment.

As shown in FIG. 9A, in this embodiment, the configuration is such that the polarities of the voltages applied to the pixel electrodes 101d in the adjustment phase are different from those in the first embodiment, with the +15 V voltage or the voltage Vcom being applied. Furthermore, as shown in FIG. 9B, in this embodiment, the configuration is such that the order of the voltage is applied to the pixel electrodes 101d in the gray level control phase is different, with the −15 V voltage being applied to the pixel electrodes 101d in the first half of the gray level control phase and the +15 V voltage or the voltage Vcom being applied in the second half of the gray level control phase.

Next, an example of operations performed when rewriting the gray levels of pixels in the second embodiment will be described. Note that in the following descriptions, a pixel A corresponds to a pixel P(1,1), a pixel B corresponds to a pixel P(1,2), a pixel C corresponds to a pixel P(1,3), and a pixel D corresponds to a pixel P(1,4); furthermore, the following describes operations performed when the pixel A is black, the pixel B is dark gray, the pixel C is light gray, and the pixel D is white prior to the rewrite and the pixel A is rewritten to white, the pixel B is rewritten to light gray, the pixel C is rewritten to dark gray, and the pixel D is rewritten to black.

Note also that in this embodiment, white is used as one base gray level, and black is used as another base gray level.

Upon obtaining the image data outputted by the control unit 2, the gray level control unit 502 writes the obtained image data into the first storage region and starts the adjustment phase. In the adjustment phase, the LUT 503 uses the table shown in FIG. 9A.

Because the gray level of the pixel A is black prior to the rewrite, the voltage Vcom is applied to the pixel electrode 101d from the first frame to the 12th frame, as indicated in FIG. 9A. In other words, according to the second embodiment, in the case where the gray level of the pixel 110 is black prior to the image rewrite, the gray level of that pixel 110 is not changed in the adjustment phase.

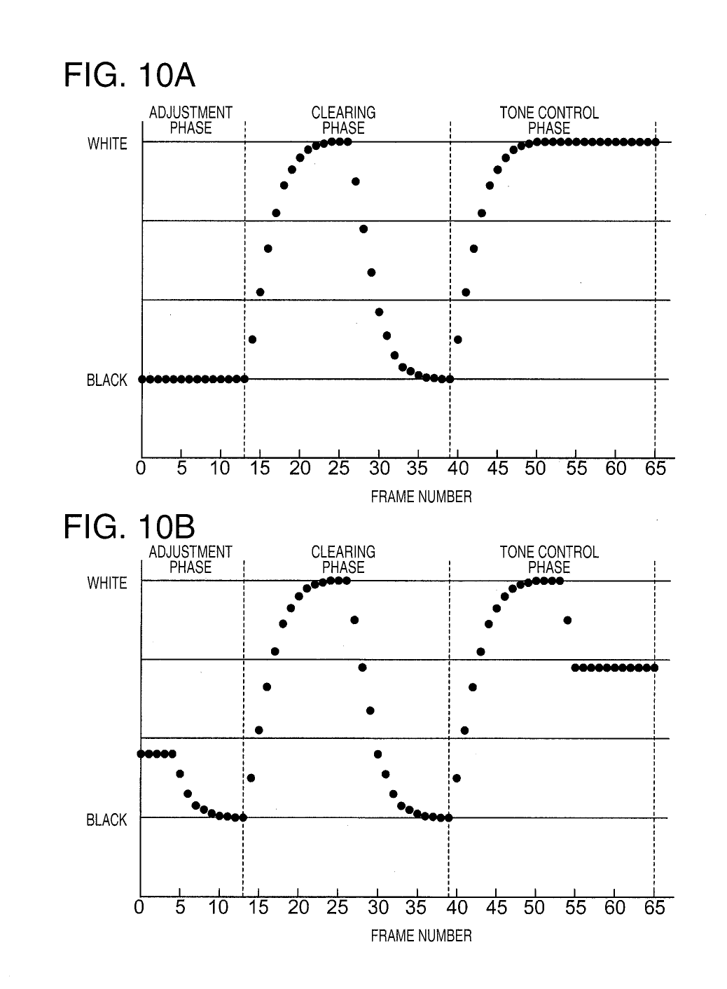

Next, because the gray level of the pixel B is dark gray prior to the rewrite, the voltage Vcom is applied to the pixel electrode 101d from the first frame to the fourth frame and the +15 V voltage is applied to the pixel electrode 101d from the fifth frame to the 12th frame, as indicated in FIG. 9A. As a result, the gray level of the pixel B approaches black from the fifth frame and becomes black in the 12th frame, as indicated in FIG. 10B.

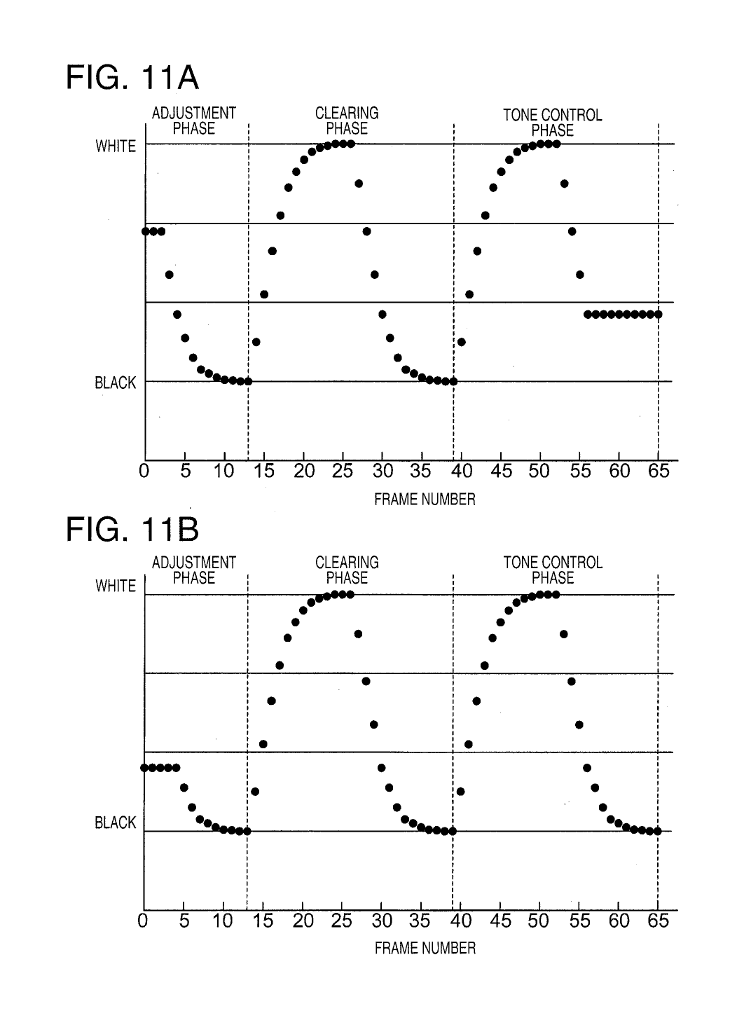

Meanwhile, because the gray level of the pixel C is light gray prior to the rewrite, the voltage Vcom is applied to the pixel electrode 101d in the first frame and the second frame, and the +15 V voltage is applied to the pixel electrode 101d from the third frame to the 12th frame, as indicated in FIG. 9A. As a result, the gray level of the pixel C approaches black from the third frame and becomes black in the 12th frame, as indicated in FIG. 11A.

Finally, because the gray level of the pixel D is white prior to the rewrite, the +15 V voltage is applied to the pixel electrode 101d from the first frame to the 12th frame, as indicated in FIG. 9A. As a result, the gray level of the pixel D approaches black from the first frame and becomes black in the 12th frame, as indicated in FIG. 11B.

Note that the voltage of the pixel electrodes 101d for all of the pixels 110 are set to the voltage Vcom in the 13th frame, which is the final frame of the adjustment phase.

According to this embodiment, in the adjustment phase, the timings at which the respective pixels reach a black display can be aligned by varying the frame at which the application of the +15 V voltage to the pixel electrode 101d begins from pixel to pixel. In this embodiment, all of the pixels reach a black display in the 12th frame, aside from the pixels that were originally displaying black. Doing so makes it possible to align the behavior of the electrophoretic particles from pixel to pixel in the 12th frame. As a result, the behavior of the electrophoretic particles from pixel to pixel can be aligned in the following phases as well, which in turn makes it possible to prevent variations in the display brightness.

When the adjustment phase ends, the gray level control unit 502 then starts the clearing phase. In the clearing phase, the −15 V voltage is applied to the pixel electrodes 101d of all of the pixels 110 from the 14th frame to the 25th frame. Accordingly, the gray levels of the pixels A through D approach white from the 14th frame and become white in the 25th frame, as indicated in FIGS. 10A to 11B. Note that the voltages of the pixel electrodes 101d for all of the pixels 110 are set to the voltage Vcom in the 26th frame. Furthermore, in the clearing phase, the +15 V voltage is applied to the pixel electrodes 101d of all of the pixels 110 from the 27th frame to the 38th frame. Accordingly, the gray levels of the pixels A through D approach black from the 27th frame and become black in the 38th frame, as indicated in FIGS. 10A to 11B. Note that the voltages of the pixel electrodes 101d for all of the pixels 110 are set to the voltage Vcom in the 39th frame.

In this manner, shifting the gray levels of all of the pixels 110 from black, to white, and to black again in the clearing phase agitates the white and black electrophoretic particles and clears a ghost of the pre-rewrite image.

When the clearing phase ends, the gray level control unit 502 starts the gray level control phase. First, the −15 V voltage is applied to the pixel electrodes 101d of all of the pixels 110 from the 40th frame to the 51st frame, as indicated in FIG. 9B. As a result, in the gray level control phase, all of the pixels 110 temporarily become white. As indicated in FIG. 9B, the voltage Vcom is applied to the pixel electrodes 101d of all of the pixels 110 in the 52nd frame.

From the 53rd frame on, for the pixel A, the voltage Vcom is applied to the pixel electrodes 101d from the 53rd frame to the 64th frame, as indicated in FIG. 9B. As a result, the gray level of the pixel A remains white, without changing, from the 53rd frame to the 64th frame, as indicated in FIG. 10A.

Meanwhile, for the pixel B that is set to light gray after the rewrite, the +15 V voltage is applied to the pixel electrode 101d in the 53rd frame and the 54th frame, and the voltage Vcom is applied to the pixel electrode 101d from the 55th frame to the 64th frame, as indicated in FIG. 9B. As a result, the gray level reaches light gray in the 54th frame, and the gray level remains light gray, without changing, from the 55th frame, as indicated in FIG. 10B.

Likewise, for the pixel C that is set to dark gray after the rewrite, the +15 V voltage is applied to the pixel electrode 101d from the 53rd frame to the 56th frame, and the voltage Vcom is applied to the pixel electrode 101d from the 57th frame to the 64th frame, as indicated in FIG. 9B. As a result, the gray level reaches dark gray in the 56th frame and remains dark gray, without changing, from the 57th frame, as indicated in FIG. 11A.

Finally, for the pixel D that is set to black after the rewrite, the +15 V voltage is applied to the pixel electrode 101d from the 53rd frame to the 64th frame, as indicated in FIG. 9B. Accordingly, the gray level becomes black in the 64th frame, as indicated in FIG. 11B.

Note that the voltages of the pixel electrodes 101d for all of the pixels 110 are set to the voltage Vcom in the 65th frame.

As described thus far, according to this embodiment as well, the adjustment phase aligns the gray levels of all of the pixels 110, and thus in the gray level control phase, the gray level control can be started from the same frame for all of the pixels 110.

Furthermore, in this embodiment as well, the voltage Vcom is applied to the pixel electrodes 101d in all of the pixels 110 after the gray levels of all of the pixels 110 have been aligned. Due to this control, the electrophoretic particles are at rest when the gray level control phase starts, and thus the gray level control is carried out in a state where the electrophoretic particles in all of the pixels 110 have equal mobility; this in turn makes it difficult for gray level differences to arise between pixels 110 that are intended to display the same gray level.

Furthermore, according to this embodiment, when displaying light gray and dark gray, both gray levels are controlled by applying the +15 V voltage to the pixel electrodes 101d from a white state and varying the number of times the voltage is applied, which makes it difficult for variations to arise in the gray level difference between light gray and dark gray.

Electronic Device

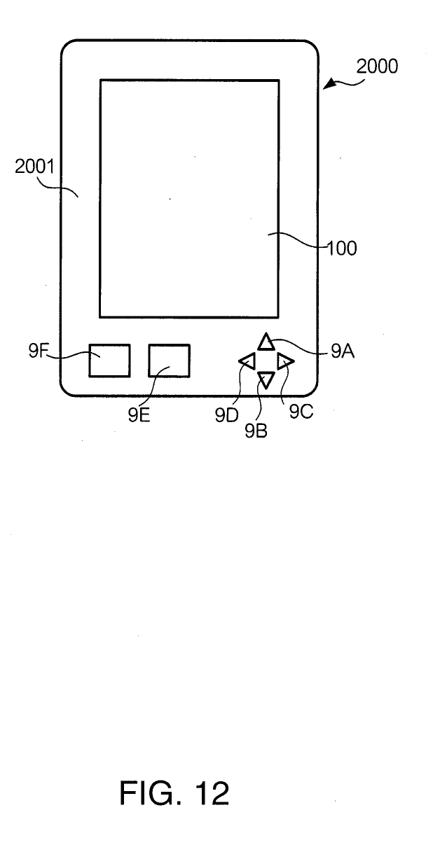

Next, an example of an electronic device in which the display device 1000 according to the aforementioned embodiments is applied will be given. FIG. 12 is a diagram illustrating the external appearance of an e-book reader that employs the display device 1000 according to the aforementioned embodiments. An e-book reader 2000 includes a plate-shaped frame 2001, buttons 9A to 9F, and the electro-optical apparatus 1 and the control unit 2 according to the aforementioned embodiments. The display region 100 is exposed in the e-book reader 2000. In the e-book reader 2000, the content of an e-book is displayed in the display region 100, and manipulating the buttons 9A to 9F turns the pages of the e-book. Note that in addition to an e-book reader, a clock, e-paper, a PDA, a calculator, a mobile telephone unit, and so on can be given as examples of electronic devices in which the electro-optical apparatus 1 according to the aforementioned embodiments can be applied.

Variations

Although the foregoing has described embodiments of the invention, the invention is not intended to be limited to the aforementioned embodiments, and the invention can be carried out in a variety of other ways. For example, the invention may be carried out by making variations such as those described hereinafter on the aforementioned embodiments. Note also that the aforementioned embodiments and the following variations may be used in combination with each other.

Although the aforementioned embodiments describe executing the adjustment phase, the clearing phase, and the gray level control phase on all of the pixels 110 in the display region 100 and rewriting the displayed image, the invention is not limited to such a configuration. For example, when rewriting the image, a region in which a gray level change occurs between the pre-rewrite image and the post-rewrite image may be identified, the aforementioned three phases may be executed for the identified region, and the voltage Vcom may be applied to the pixel electrodes 101d of the pixels 110 located outside the identified region.

In the invention, the numbers of frames in each phase are not limited the numbers mentioned above, and other numbers may be used as well. In addition, although the aforementioned embodiments describe applying the +15 V voltage to the pixel electrode 101d 12 times when changing the gray level from white to black, this application may be carried out 11 times or less or 13 or more times. Likewise, although the aforementioned embodiments describe applying the −15 V voltage to the pixel electrode 101d 12 times when changing the gray level from black to white, this application may be carried out 11 times or less or 13 or more times. Furthermore, the numbers of times the −15 V or +15 V voltage is applied when displaying half gray levels are not limited to the numbers described in the aforementioned embodiments, and other application numbers may be used as well.

Furthermore, in the aforementioned embodiments, a temperature of the display region 100 may be measured using a temperature sensor, and the number of frames in each phase, the number of times the +15 V or −15 V voltage is applied, and so on may be changed in accordance with the measured temperature.

Although the above embodiments describe an active matrix-type electro-optical apparatus as an example, the invention is not limited thereto. The electro-optical apparatus may have a segment-type configuration in which a segmented electrode is provided as the first electrodes. In this case, the distance the electrophoretic particles move, or in other words, the magnitude of the gray level changes, are determined based on the amount of time for which a voltage is applied to the segmented electrode. Accordingly, replacing the number of frames for which the voltage is applied to the pixel electrode 101d with the amount of time for which the voltage is applied to the segmented electrode in the aforementioned embodiments enables the invention to be embodied as a segment-type electro-optical apparatus. With a segment-type electro-optical apparatus, in the adjustment phase, a gray level control unit applies a voltage that changes the gray level of a pixel to the opposite-direction gray level to the segmented electrode for an application time that is based on a gray level difference between the gray level of the pixel prior to the change and the other base gray level; the voltage application time is extended, and the application of the voltage is started earlier, for pixels in which this gray level difference is greater.

Although the above embodiments describe an apparatus having the electrophoretic layer 102 as an example of the electro-optical apparatus, the invention is not intended to be limited thereto. The electro-optical apparatus may be any apparatus in which a write operation for changing the display state of a pixel is a write operation that applies a voltage a plurality of times, and may be an electro-optical apparatus that employs an electronic particle fluid as an electro-optical material, for example.

Although the aforementioned embodiments describe the electro-optical apparatus 1 as being configured to display four gray levels, namely black, dark gray, light gray, and white, the number of gray levels displayed is not limited to four. For example, the configuration may be such thagray level of dark gray and light gray is not displayed, or in other words, in which three gray levels are displayed. Furthermore, gray levels aside from dark gray and light gray may be displayed as half gray levels, and five or more gray levels may be displayed as well.

Although the aforementioned embodiments describe a configuration in which the voltage Vcom is applied to the pixel electrodes 101d in the final frame of each phase, the invention is not limited to such a configuration. For example, the configuration may be such that the voltage Vcom is applied to the pixel electrodes 101d in the final frame of at least gray level of the three phases.

This application claims priority from Japanese Patent Application No. 2013-042673 filed in the Japanese Patent Office on Mar. 5, 2013, the entire disclosure of which is hereby incorporated by reference in its entirely.

1. A control device for an electro-optical apparatus, the apparatus including a first electrode provided for each of a plurality of pixels, a second electrode disposed facing the first electrodes, and a bi-stable electro-optical material interposed between the first electrodes and the second electrode, the control device comprising:
a gray level control unit that rewrites an image displayed by the plurality of pixels,
wherein in an adjustment phase in which the gray level control unit changes gray levels of the plurality of pixels to a predetermined one base gray level over a plurality of frames, the gray level control unit applies a voltage to the first electrodes a greater number of application times and begins the voltage application at an earlier frame for pixels having a greater difference between a pre-change gray level and the one base gray level.

2. The control device according to claim 1,
wherein a period in which the image is rewritten includes a gray level control phase that follows the adjustment phase and in which a voltage for changing the gray levels of the pixels is applied to the first electrodes based on image data and the gray levels of the pixels are changed over a plurality of frames; and
the gray level control unit starts the application of the voltage for changing the gray level at the same frame for pixels whose gray levels are to be changed from the gray levels present at the start of the gray level control phase.

3. The control device according to claim 2,
wherein the gray level control unit applies the voltage to the first electrodes consecutively for the application times in the adjustment phase and the gray level control phase.

4. The control device according to claim 2,
wherein the period in which the image is rewritten includes a clearing phase that is provided between the adjustment phase and the gray level control phase and that changes the plurality of pixels to another base gray level that differs from the one base gray level at least once and changes the pixels to the one base gray level at least once.

5. The control device according to claim 4,
wherein the electro-optical material is electrophoretic particles; and
the gray level control unit applies a voltage that stops movement of the electrophoretic particles to the first electrodes at the end of at least gray level of the adjustment phase, the clearing phase, and the gray level control phase.

6. The control device according to claim 1,
wherein the gray level control unit sets the polarity of the voltage applied to the first electrodes to one polarity until the pixels change to the other base gray level and sets the polarity of the voltage applied to the first electrodes to another polarity until the pixels change to the one base gray level.

7. A control device for an electro-optical apparatus, the apparatus including a first electrode provided for each of a plurality of pixels, a second electrode disposed facing the first electrodes, and a bi-stable electro-optical material interposed between the first electrodes and the second electrode, the control device comprising:
a gray level control unit that rewrites an image displayed by the pixels in an image rewrite period having an adjustment phase,
wherein the adjustment phase is a phase that changes gray levels of the pixels from a half gray level or a predetermined one base gray level to a predetermined other base gray level in a predetermined period; and
in the adjustment phase, the gray level control unit applies a voltage that changes the gray levels of the pixels toward the other base gray level to the first electrodes for an application time based on a gray level difference between the pre-change gray levels of the pixels and the other base gray level, and applies the voltage for a longer application time and begins the voltage application earlier the greater the gray level difference is.

8. An electro-optical apparatus having a first electrode provided for each of a plurality of pixels, a second electrode disposed facing the first electrodes, and a bi-stable electro-optical material interposed between the first electrodes and the second electrode, the apparatus comprising:
a gray level control unit that rewrites an image displayed by the pixels in an image rewrite period having an adjustment phase,
wherein the adjustment phase is a phase that changes gray levels of the pixels from a half gray level or a predetermined one base gray level to a predetermined other base gray level over a plurality of frames; and
in the adjustment phase, the gray level control unit applies a voltage that changes the gray levels of the pixels toward the other base gray level to the first electrodes for a number of application times based on a gray level difference between the pre-change gray levels of the pixels and the other base gray level, and applies the voltage for a higher number of application times and begins the voltage application at an earlier frame the greater the gray level difference is.

9. An electronic device comprising the electro-optical apparatus according to claim 8.
